(19) United States
(12) Patent Application Publication
(10) Pub. No.: US 2003/0110176 A1
(43) Pub. Date: Jun. 12, 2003

(54) Maintaining interoperability of systems that use different metadata schemas

(76) Inventors: Oliver Morgan, Lexington, MA (US); Timothy J. Bingham, Westford, MA (US); Thomas R. Ransdell, Chelmsford, MA (US)

Correspondence Address: PETER J. GORDON, PATENT COUNSEL, AVID TECHNOLOGY, INC., ONE PARK WEST, TEWKSBURY, MA, 01876, US

(21) Appl. No.: 10/013,097

(22) Filed: Dec. 6, 2001

(51) Int. Cl. G06F 7/00

(52) U.S. Cl. 707/100

(57) ABSTRACT

To manage forward and backward compatibility, a mechanism is provided through which evolved and synthesized property definitions may be added by a new implementation that uses data from an old implementation. The definitions are associated with code that rename, reformat or otherwise manage access to the properties for which an old schema and a new schema are different. Such mechanisms generally allow an application using a first implementation of a metadata schema to access data stored using a second implementation of a metadata schema by specifying an evolved property definition in the first implementation to refer to a corresponding property definition in the second implementation, for each property in the first implementation that is different from a corresponding property in the second implementation. Accesses are redirected using the evolved property definition to access the corresponding property definition in the second implementation. Also, such mechanisms generally allow an application using a first implementation of a metadata schema to access data stored using a second implementation of a metadata schema, by specifying a synthesized property definition in the first implementation for each property in the first implementation that lacks a corresponding property definition in the second implementation. Information about accesses to the synthesized property definition then is maintained during use of the second implementation.

### BACKGROUND

In a multimedia system, there are in general two types of data: essence and metadata. Essence is data that informs a presentation device what to present to a viewer, such as video data, audio data, graphics data, text data and other data that is presented to the viewer in some sensory manner. Metadata is data about an essence.

A need has arisen for a vocabulary of metadata items and for data structures to manage collections of metadata in relation to each other and in relation to the essence that they describe. Such vocabularies of metadata are being developed through standardization efforts as the Society of Motion Picture and Television Engineers' (SMPTE) key-length-value (KLV) Encoding and Metadata Dictionary, the Advanced Authoring Format (AAF) Association, and ISO SC29 WG11 MPEG-7. Other vocabularies of metadata include the British Broadcasting Corporation's Open Standard Media Exchange Format (OpenSMEF) and Avid Technology's Open Media Framework (OMF).

A vocabulary of metadata, also called a schema, has the benefit of enabling a baseline of communication between subsystems, but faces several practical limitations. First, not everyone will use the same schema, or even a subset of the same schema. Second, users may add extensions to a public standardized schema, and such extensions may be published or private. Third, even standardized schemas will be modified and extended over time. Fourth, even if two parties use a single schema, their usage may differ from each other due to different interpretations of the standard. Finally, in the process of a new schema becoming widely used and then standardized, names or identifiers used in the schema may change without changing their underlying meanings or purposes. However, such changes may result in incompatibilities with existing implementations of the pre-standardized schema.

There are several kinds of schema compatibility that may be accommodated. The following definitions are provided to describe these kinds of compatibility. An “old implementation” of a schema is the implementation of the schema before a schema change has been made. The “new implementation” of a schema is the implementation of the schema after a schema change has been made. “Backward compatibility” signifies the ability of an application using a new implementation of a schema to correctly understand the output of an application using an old implementation of a schema. “Forward compatibility” signifies the ability of an application using an old implementation of a schema to correctly understand the output of an application using a new implementation of a schema.

Some systems only support “fixed schema” in which no changes are allowed so compatibility is not an issue.

In some applications, a “schema revolution” occurs in which the schema is changed without providing forward or backward compatibility. If a schema revolution occurs between versions of an application, a user must choose to either remain with the old implementation to access data, or move to the new implementation and lose data. Sometimes data is converted en masse from the old to the new schema after a schema revolution.

Some systems do not require conversion, but allow for only backward compatibility. In such applications, all attributes of objects are uniquely tagged. All implementations (whether old or new) ignore attributes in an object that are not part of the schema for the implementation. Backward compatibility is simplified if it is “constrained” such that a new implementation permits only the addition of attributes. The removal of attributes is not permitted. The constrained approach involves the introduction of optional attributes. An optional attribute may be validly absent from object instances. That is, object instances without the attribute still conform to the schema. The only schema changes allowed are the addition of optional attributes. Such a change does not invalidate existing object instances.

For example, AAF supports backward compatibility to the extent that with a new implementation, old objects are treated as valid instances of the new class in which any added optional attribute happens to be legally absent. It supports forward compatibility to the extent that old implementations ignore any added optional attribute in data from a new implementation if such an optional attribute is present. If an old implementation updates a new file, inconsistencies can occur if the value of the ignored attribute depends upon attributes that are modified.

With different systems that use different metadata schemas, it may be difficult to provide interoperability or compatibility among such systems.

### SUMMARY

A mechanism translates data in different metadata schemas in a systematic and dynamic fashion and maintains interoperability of systems that use different metadata schemas, particularly as metadata schemas evolve. This mechanism may permit arbitrary user-defined extensions to a metadata schema while providing dynamic translation of data from one metadata schema to another and back again.

In general, the mechanism involves several operations. First, a mismatch between a stored object and the currently known schema describing objects of that class is detected. Second, the implementation is notified that a mismatch has occurred. Third, the mismatch is corrected.

There are four cases to consider based on combinations of addition and removal of an attribute (also called a property) of an object class from a schema and forward and backward compatibility.

In the first case, in which an attribute is added in a new implementation, an application supports backward compatibility to allow the expected attribute not to be present in data received from another application. Because the added attribute is not present in old files a mismatch is detected. The mismatch can be corrected by synthesizing the attribute or by notifying a new implementation that includes code to convert old objects into new ones.

In the second case, in which an attribute is added in a new implementation, an application supports forward compatibility to allow an old application to accept an object that includes an attribute that is not expected but present. The new attribute is discarded if the metadata is read in from storage and provided to the application. Inconsistencies may be introduced if a new file is modified by an old implementation.

In the third case, in which an attribute is removed in a new implementation, an application supports backward compatibility to allow a new application to accept an object that includes an attribute that is not expected but present. In this case, the attribute is no longer needed. Therefore, it can be ignored if the metadata is read in from storage and provided to the application.

In the fourth case, in which an attribute is removed in a new implementation, an application supports forward compatibility to allow an old application to accept an object that does not include an attribute that is expected but not present. There are several options for handling this case. The attribute may be synthesized and a default value may be supplied, e.g., integer=0, real=0.0, string=“ ”. Alternatively, the attribute may be synthesized and a default value may be obtained from a value or rule built in to the implementation or from a value or rule stored in the file along with the data, for example, by adding default values to an enhanced AAF dictionary. Alternatively, a new value for the attribute may be computed using plug-in code that is specifically for converting new objects into old ones and may be stored or described in the file along with the data.

To manage forward and backward compatibility with addition and removal of attributes between different schemas, a mechanism is provided through which evolved and synthesized property definitions may be added by one implementation that uses data from another implementation. The definitions are associated with code that rename, reformat or otherwise manage access to the properties for which an old schema and a new schema are different.

### BRIEF DESCRIPTION OF THE DRAWINGS

FIG. 1 is an illustration of packaging of metadata and essence using AAF;

FIG. 2 is a block diagram of an AAF SDK and its interaction with one or more applications and an operating system; and

FIG. 3 is a diagram of a system in which multiple applications may access essence and metadata using different metadata schemas.

### DETAILED DESCRIPTION

A detailed description of an example application will now be described. In this description, the example metadata formats to be described are based on the Advanced Authoring Format (AAF).

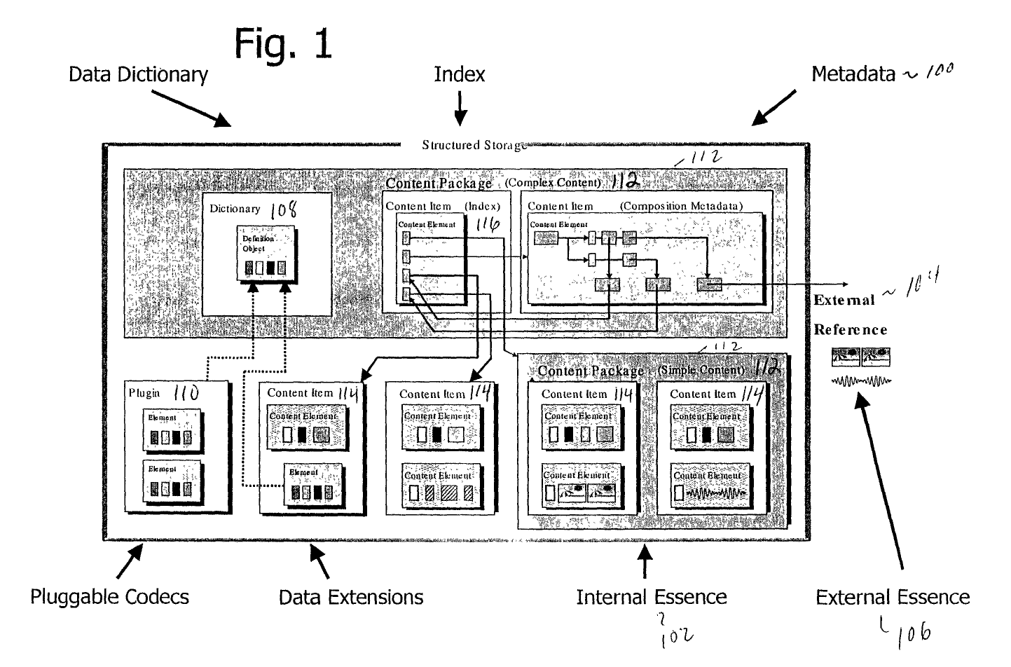

Referring to FIG. 1, in a multimedia system, there are in general two types of data: essence and metadata. Essence is data that informs a presentation device what to present to a viewer, such as video data, audio data, graphics data, text data and other data that is presented to the viewer in some sensory manner. Metadata is data about an essence.

AAF defines a packaging format for data. This packaging format includes metadata 100, “internal” essence 102 (for simple essence such as graphics) and references 104 to “external” essence 106 (for complex essence such as video data). A dictionary 108 is a description of the schema to which the metadata conforms. Files including data in an AAF format include this dictionary. A “plug-in” mechanism 110 specifies any plug-in used by the data, for example, a codec or other executable code for a particular kind of data. The metadata 100 specifies one or more content packages 112, each including one or more content items 114 and/or one or more other content packages 112. One of the content items is an index 116 of the data in the package. An item may refer to one or more objects. Each object has one or more attributes (also called properties), that are defined by a key (or name), a value, and optionally a length or other information descriptive of the value. Further details about the AAF specification may be found at http://ww.aafassociation.org.

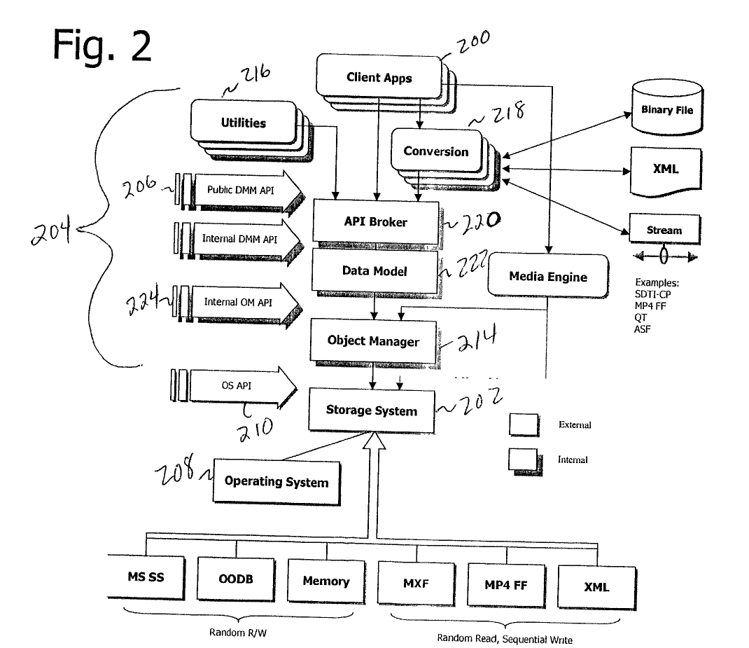

How AAF is used by an application will now be described in connection with FIG. 2. One or more client applications 200 access data in AAF format stored on a storage system 202 via an AAF software development kit (SDK) 204. The SDK receives commands from an application 200 through a public API 206, and issues commands to an operating system 208 through an OS API 210. A media engine 212 communicates with the storage system 202 and client application 200, as well as an object manager 214 of the AAF SDK to process and/or present media data. The AAF SDK currently is publicly available through http://ww.aafassociation.org.

The AAF SDK includes utilities 216 useful for developers and conversion applications 218 for converting data between different metadata schemas. Such differences might exist between the schema of the data being accessed and the schema of data used by external applications. The utilities and conversion applications may be “plug-in”s that may be added to AAF SDK through a plug-in mechanism provided by the AAF SDK. An API broker 220 implements the public API 206 that is used by the utilities 216, conversion applications 218 and client applications 200 to access the data model 222, which in turn accesses the object model 214 to access stored data. The data model 222 includes a mechanism to process objects (attribute sets) and modify them. The mechanisms for maintaining interoperability with different metadata schemas may be added to this data model. The object manager 214 includes a mechanism to handle constrained evolution, as described below. The object manager 214 implements an API 224 that allows access by both the data model 222 and the media engine 212.

The AAF SDK has a mechanism through which new property definitions of an object may be added to the object, called “RegisterPropertyDefinition”. Through this mechanism, two property definitions are added to an object to manage evolution of the metadata schema. These two property definitions are called an evolved property definition (EvolvedPropertyDef) and a synthesized property definition (SynthPropertyDef). These new property definitions are stored in the dictionary of the schema maintained by the SDK and the file. The application is aware of its own schema.

An evolved property definition encapsulates rules for renaming and reformatting of attributes between schema. The rules may be simple or complex. An example of a simple rule is a change in an attribute called “weight” in a first schema, for which the units are “pounds”, to an attribute called “mass” in a second schema, for which the units are “kilograms”. In this example, the rule would indicate the following: new_name:mass; new_format:kilograms; old_name:weight; old_format:pounds; forward conversion:mass=weight*2.2; backward_conversion:weight=mass/2.2. In a complex case, the conversions may be defined as references to computer program code that may be executed or interpreted to perform the conversion.

A synthesized property definition encapsulates rules for addition of attributes.

Code to interpret these new property definitions may be provided as a plug-in to an existing AAF SDK or may be added to a new version of the AAF SDK. If such an SDK is used with a new implementation, it uses the evolved and synthesized property definitions to evolve data from the old implementation. If such an SDK is used with an old implementation, it uses the evolved and synthesized property definitions to evolve data from the new implementation. How these property definitions are used to maintain interoperability among applications that use different metadata schemas will be defined in more detail below.

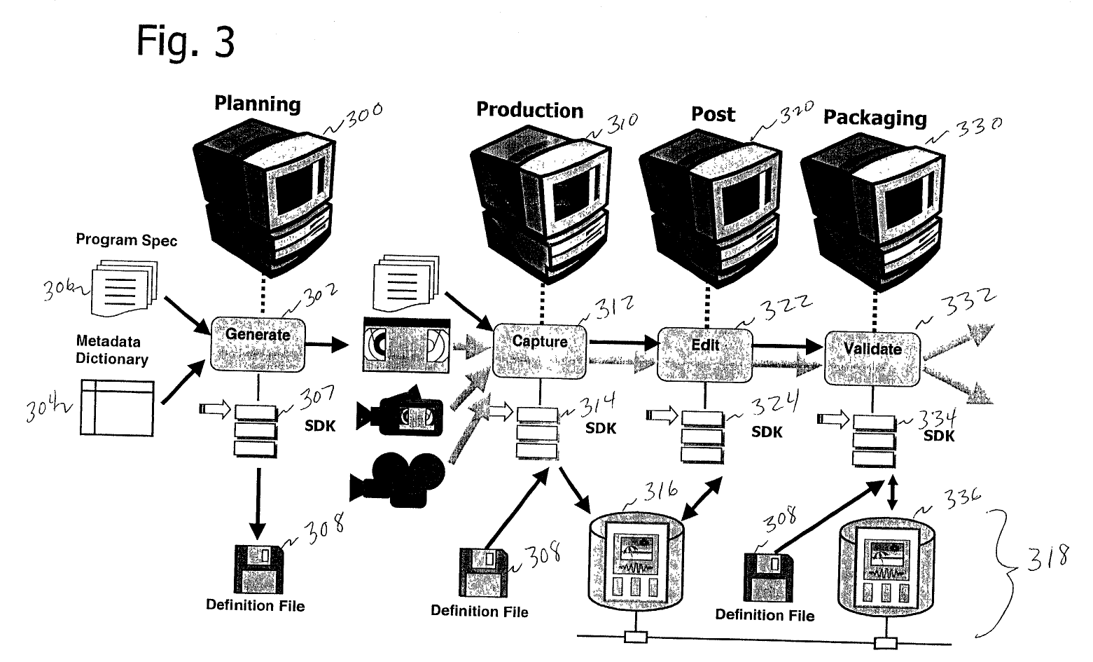

Referring now to FIG. 3, an example of how such differences in metadata schemas may arise will now be described. FIG. 3 illustrates several systems that are used in the creation and delivery of multimedia program.

In this example, a planning system 300 is used to generate information prior to production of media data about the program that will be created. An application 302 (called “generate”) receives information such as a metadata dictionary 304 and program specification 306 and uses the AAF SDK 307 (such as described above in connection with FIG. 2) to generate a definition file 308.

A production system 310 may include an application 312 (called “capture”) that uses the definition file 308 through an AAF SDK 314 to output further data and essence 316, which may be stored on shared storage 318. In other implementations data may be sent over a computer network or delivered on computer readable storage media from one system to another system instead of through shared storage.

A post-production system 320 may include an application 322 (called “edit”) that uses the data and essence 316 through an AAF SDK 324 to modify and/or change the data and essence 316.

A packaging system 330 may include an application 332 (called “validate”) that uses the data and essence 316 and definition file 308 through an AAF SDK 334 to generate a final product, stored as data and essence 336 on the shared storage 318.

Other systems also may be included in this system, such as systems that include applications for synthesizing new data, analyzing data, delivering data to presentation devices, consuming data (such as a presentation device), and archiving data.

Each of these systems may include applications that use different metadata schemas, or that use different AAF SDKs which implement different metadata schemas. In a configuration that uses multiple systems that use different metadata schemas, mechanisms for evolving data between the different metadata schemas are used to maintain interoperability of these systems. There are several cases that may arise in which metadata schemas are different. Some changes involve attribute renaming and renaming with type changes. In these changes, there is a one-to-one correspondence between old and new schemas, but different data types. There are different cases depending on how the different data types can be converted. These cases are:

1. A new Key is given to a Property, and the Type remains the same.

2. A new Key is given to a Property, with a new Type, but data is bidirectionally convertible, old data to new data and new data to old data, by simple reformatting, i.e., only a syntax change has been made.

3. A new Key is given to a Property, with a new Type, but data is bidirectionally convertible, old data to new data and new data to old data using a known algorithm, i.e., a program is used to convert the data.

4. A new Key is given to a Property, with a new Type, but data is unidirectionally convertible from the old schema to the new schema, i.e., it is not possible to write a program to convert all new values to old values.

Some changes involve a new schema that adds attributes to the old schema. With these changes, there are different cases that depend on whether the data values of the new attribute can be constructed within the context of the object. These cases are:

5. Data values of the new attribute can be constructed from other attributes from the old schema or from the old and new schemas within the context of the object, including embedded objects and reference targets.

6. Data values of the new attribute cannot be constructed from other attributes within the context of the object.

Some changes involve a new schema that deletes attributes from an old schema. With these changes, there are different cases that depend on whether the data values of the old attribute can be reconstructed. These cases are:

7. Data values of the old attribute can be reconstructed from other old attributes within the context of the object, including embedded objects and reference targets.

8. Data values of the old attribute can be reconstructed from a combination of old and new attributes within the context of the object, including embedded objects and reference targets.

9. Data values of the old attribute cannot be reconstructed.

For these cases, the use of the evolved property definition (which deals with cases 1 through 4) and the synthesized property definition (which deals with cases 5 through 9) supports forward compatibility and backward compatibility. Also supported are two kinds of “round trip”: a first kind of round trip is a transfer of data from an old implementation to a new implementation and back to the old implementation; a second kind of round trip is a transfer of data from a new implementation to an old implementation and back to the new implementation.

For cases 1 through 4, compatibility is provided by the evolved property definition, which may be called “EvolvedPropertyDef”, or EPD. An “EvolvedPropertyDef” (EPD) defines a property with a Target property name as a function of a Source property. Type conversion is specified within the EPD for both directions. For simple cases, the relevant Type is specified (as a weak reference to an existing Type). For more complex cases (such as enumerated types with text representations) conversion is specified as a weak reference to optional pluggable code called a “thunk”. In effect, an EPD creates the Target as a virtual Property, which is not itself persisted. Calls to access methods (also called accessors) of the property is redirected by the SDK to the actual Source property, possibly with Type reformatting on the way.

More particularly, for backward compatibility, if a new implementation opens a file from an old implementation, it registers EvolvedPropertyDefs for all the old properties it does not understand. In each of these the Target name is the Key of the attribute in the new schema, and the Source name is the Key of the attribute in the old schema. These EPDs may be created from scratch by the newer application, or may be read in from an auxiliary file that includes these EPDs. This auxiliary file may contain only the necessary EPDs.

In case 1, the accessors for the new attribute are redirected using the AAF SDK “direct property access” functions. That is, a Set(Target) is interpreted as a Set(Source). No Type conversion is performed. In case 2, the accessors for the new attribute are redirected using the AAF SDK “direct property access” functions, with additional calls to perform Type conversion. In case 3, the accessors for the new attribute are redirected using the pluggable thunk. In case 4, the accessors for the new attribute are redirected using the pluggable thunk, but the Set accessor fails. If no case 4 data occurs, then the data file after use by the new implementation conforms to the old schema. Thus, the first kind of round trip is supported with the above functionality.

There are two ways to provide forward compatibility: (i) by enabling an old implementation to interpret files conforming to the new schema, and/or (ii) by enabling the new implementation to produce files conforming to the old schema.

Forward compatibility can be provided by an old application in the following way. An old implementation detects that files in a new implementation are missing the attributes in the old schema that have been renamed in the newer schema. But an old implementation can be enabled to interpret the new schema by registering EPDs in which the Target is the Key of the attribute in the old schema, and the Source is the Key of the attribute in the new schema. These EPDs, however, can be read in from an auxiliary file that includes these EPDs. Such an auxiliary file may be created for an old implementation when a new schema is designed. This auxiliary file may contain only the necessary EPDs.

An old implementation might have been built using an older SDK that lacks the capability for EPDs. However, the capability to create and interpret EPDs can be provided through Class Extension Plug-ins which are implemented even in the AAF V1.0 SDK.

Using these techniques, a file created by or touched by an older implementation will be a bona fide newer file.

Forward compatibility can be provided by a new application in the following way. The new application is provided with the identity of the schema to which the old application conforms. Then the new application registers EPDs for all the changed properties, in which the Target is the Key of the attribute in the old schema, and the Source is the Key of the attribute in the new schema. These EPDs may be created from scratch by the new application, or may be read in from an auxiliary file that contains these EPDs. This auxiliary file may contain only the necessary EPDs.

For cases 1 through 4, the second kind of round trip is supported with the above functionality because files always conform to the newer schema.

Cases 5, 7 and 8 are handled in almost the same way. However, in these cases, the added attribute is synthesized from the values of other attributes. To distinguish these cases from the renaming cases, the property definition that implements this synthesis is called a synthesized property definition, or “SynthesizedPropertyDef” (or SPD). An SPD always has an associated pluggable thunk that synthesizes the added attribute. All classes including synthesized properties are subclasses of the older class. The synthesized property data may be persisted, for optimization. Applications can ignore out of date synthesized attributes if generation tracking occurs separately for classes and subclasses.

Cases 6 and 9 are handled by the SDK that detects a mismatch between the stored object and the currently known schema. The SDK then notifies the application that a mismatch has occurred. No correction is made.

The foregoing examples describe how compatibility is maintained between different systems using different schemas. The mechanisms described above are not limited to two different systems. Compatibility among three or more systems can be maintained by treating the systems as a collection of pairs. Three or more systems also may be treated as a chain through which compatibility is maintained. For example, given three systems X, Y and Z, compatibility can be maintained by providing for translation between system X and system Y and between system Y and system Z (as a chain). By adding translation between system X and system Z, the systems are treated as a collection of pairs. For N different schemas, the use of pairs would result in the use of N*(N−1)/2 sets of evolved property definitions and synthesized property definitions. The use of chains would result in the use of N−1 sets of evolved property definitions and synthesized property definitions. The foregoing examples illustrate how the AAF SDK may be used to maintain interoperability between different AAF schemas. Similar mechanisms may be provided to provide interoperability between different kinds of schemas, such as standardized schemas, e.g., SMPTE KLV, and nonstandard schemas, such as OMF. Thus the invention is not limited to AAF. The invention can be applied to any metadata processing system that retains the schema description and provides traceability from a particular file to the schema used by that file. The schema could be stored separately from the file or together with it. The schema could be stored in a markup language format, such as XML, or binary format, or other format.

Such mechanisms to provide interoperability generally allow an application using a first implementation of a metadata schema to access data stored using a second implementation of a metadata schema by specifying an evolved property definition in the first implementation to refer to a corresponding property definition in the second implementation, for each property in the first implementation that is different from a corresponding property in the second implementation. Accesses are redirected using the evolved property definition to access the corresponding property definition in the second implementation. Also, such mechanisms generally allow an application using a first implementation of a metadata schema to access data stored using a second implementation of a metadata schema, by specifying a synthesized property definition in the first implementation for each property in the first implementation that lacks a corresponding property definition in the second implementation. Information about accesses to the synthesized property definition then is maintained during use of the second implementation.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A system for allowing an application using a first implementation of a metadata schema to access data stored using a second implementation of a metadata schema, comprising:
means for specifying an evolved property definition in the first implementation to refer to a corresponding property definition in the second implementation, for each property in the first implementation that is different from a corresponding property in the second implementation; and
means for redirecting accesses using the evolved property definition to access the corresponding property definition in the second implementation.

2. The system of claim 1, wherein the means for specifying comprises:
means for executing stored instructions for deriving one schema from another.

3. The system of claim 1, wherein the means for specifying comprises:
means for accessing stored information describing two schemas; and
means for determining a difference between the two schemas.

4. A system for allowing an application using a first implementation of a metadata schema to access data stored using a second implementation of a metadata schema, comprising:
means for specifying a synthesized property definition in the first implementation for each property in the first implementation that lacks a corresponding property definition in the second implementation; and
means for maintaining information about accesses to the synthesized property definition.

5. The system of claim 4, wherein the means for specifying comprises:
means for executing stored instructions for deriving one schema from another.

6. The system of claim 4, wherein the means for specifying comprises:
means for accessing stored information describing two schemas; and
means for determining a difference between the two schemas.

7. A method for allowing an application using a first implementation of a metadata schema to access data stored using a second implementation of a metadata schema, comprising:
specifying an evolved property definition in the first implementation to refer to a corresponding property definition in the second implementation, for each property in the first implementation that is different from a corresponding property in the second implementation; and
redirecting accesses using the evolved property definition to access the corresponding property definition in the second implementation.

8. The method of claim 7, wherein specifying comprises:
executing stored instructions for deriving one schema from another.

9. The method of claim 7, wherein specifying comprises:
accessing stored information describing two schemas; and
determining a difference between the two schemas.

10. A method for allowing an application using a first implementation of a metadata schema to access data stored using a second implementation of a metadata schema, comprising:
specifying a synthesized property definition in the first implementation for each property in the first implementation that lacks a corresponding property definition in the second implementation; and
maintaining information about accesses to the synthesized property definition.

11. The method of claim 10, wherein specifying comprises:
executing stored instructions for deriving one schema from another.

12. The method of claim 10, wherein specifying comprises:
accessing stored information describing two schemas; and
determining a difference between the two schemas.

13. A system for allowing an application using a first implementation of a metadata schema to access data stored using a second implementation of a metadata schema, comprising:
means for detecting a mismatch between a stored object of a class from the first implementation and the metadata schema of the second implementation describing objects of the class; and
means for notifying the second implementation of any detected mismatch.

14. The system of claim 13, further comprising:
means for correcting the mismatch.

15. A method for allowing an application using a first implementation of a metadata schema to access data stored using a second implementation of a metadata schema, comprising:
detecting a mismatch between a stored object of a class from the second implementation and the metadata schema of the first implementation describing objects of the class; and
notifying the first implementation of any detected mismatch.

16. The method of claim 15, further comprising:
correcting the mismatch.
